(19) United States
(12) Patent Application Publication
(10) Pub. No.: US 2007/0278050 A1
(43) Pub. Date: Dec. 6, 2007

(54) TOE POSITION CONTROL

(76) Inventors: George D. Larson, Roseville, MN (US); Daniel L. Jankovich, Minneapolis, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/758,766

(22) Filed: Jun. 6, 2007

Related U.S. Application Data
(60) Provisional application No. 60/811,402, filed on Jun. 6, 2006.

(51) Int. Cl. F16D 63/00; F16D 51/00

(52) U.S. Cl. 188/82.6; 188/77 W

(57) ABSTRACT

One aspect is a wrap device including first and second hubs. The first hub is configured with first cam features and the second hub is configured with second cam features. The first and second hubs are configured so that one is rotatable relative to the other about an axis in first and second circumferential directions with respect to the hubs. The wrap device includes a wrap configured with a wrap toe and configured to span the first and second hubs. The first and second cam features of the first and second hub control the wrap toe upon relative rotation of first and second hubs such that the wrap toe is deflected in at least one of the first and second circumferential directions, and such that the wrap toe is deflected in a first deflection direction that is different than the first and second circumferential directions.

### CROSS-REFERENCE TO RELATED APPLICATIONS

This patent application claims priority under 35 U.S.C. § 119(e) to U.S. Provisional Patent Application Ser. No. 60/811,402 entitled “ARM REST CLUTCH,” having a filing date of Jun. 6, 2006, the contents of which are incorporated herein by reference.

### BACKGROUND

One aspect of the present invention relates to a wrap device, and particularly to a wrap device including a wrap toe that is positionally controlled.

In many applications it may be desirable to pivotally position one element relative to another. For example, it may be desirable to hinge an element relative to a base. Furthermore, it may be desirable to easily move the hinged element relative to the base, and then have the hinged element remain steady in a selective position relative to the base. For example, one application may include a chair having one or more arm rests pivotally mounted on the chair that can be moved up and down in accordance with the user's desired position. In one case, it may be desirable to allow the user to rotate the arm relative to the chair until it reaches a position desired by the user. Once the user stops moving the arm, the arm then remains locked in that position, especially resistive to downward movement. In this way, it can support the user's arm which may rest on it.

In some cases, such pivotally moveable arm rests require a latch or other release mechanism to allow the user to rotate the arm rest to the desired position. Other such systems require a variety of complex parts, which can be expensive, or even noisy in operation.

For these and other reasons, there exists a need for the present invention.

### SUMMARY

One embodiment is a wrap device including an input and an output. The first hub is configured with first cam features and the second hub is configured with second cam features. The first and second hubs are configured so that one is rotatable relative to the other about an axis in first and second circumferential directions with respect to the hubs. The wrap device includes a wrap configured with a wrap toe and configured to span the first and second hubs. The first and second cam features of the first and second hub control the wrap toe upon relative rotation of first and second hubs such that the wrap toe is deflected in at least one of the first and second circumferential directions, and such that the wrap toe is deflected in a first deflection direction that is different than the first and second circumferential directions.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates of a wrap device in accordance with one embodiment of the present invention.

FIG. 2 illustrates a cross-sectional view of a wrap device in accordance with one embodiment of the present invention.

FIG. 3 illustrates a perspective view of an input shaft of a wrap device in accordance with one embodiment of the present invention.

FIG. 4 illustrates a grounded hub for a wrap device in accordance with one embodiment of the present invention.

FIG. 5 illustrates a side view of a chair including an arm rest pivoted with a wrap device in accordance with one embodiment of the present invention.

FIGS. 6-11 illustrates an assembled wrap device at several varying relative positions in accordance with one embodiment of the present invention.

FIG. 12 illustrates a wrap with wrap toe for a wrap device in accordance with one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

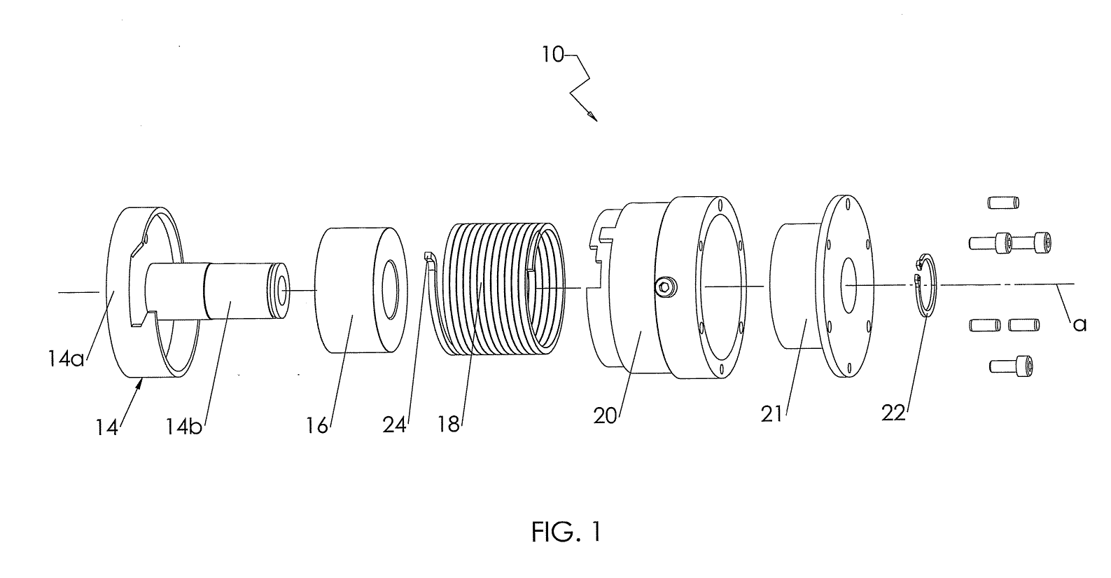

FIG. 1 illustrates wrap device 10 in accordance with one embodiment of the present invention. In one embodiment, wrap device 10 includes input shaft 14, wrap hub 16, wrap 18, output hub 20, grounding hub 21, and retaining ring 22, which are illustrated about axis a. In one embodiment, input shaft 14 has an input cam portion 14a and a shaft portion 14b.

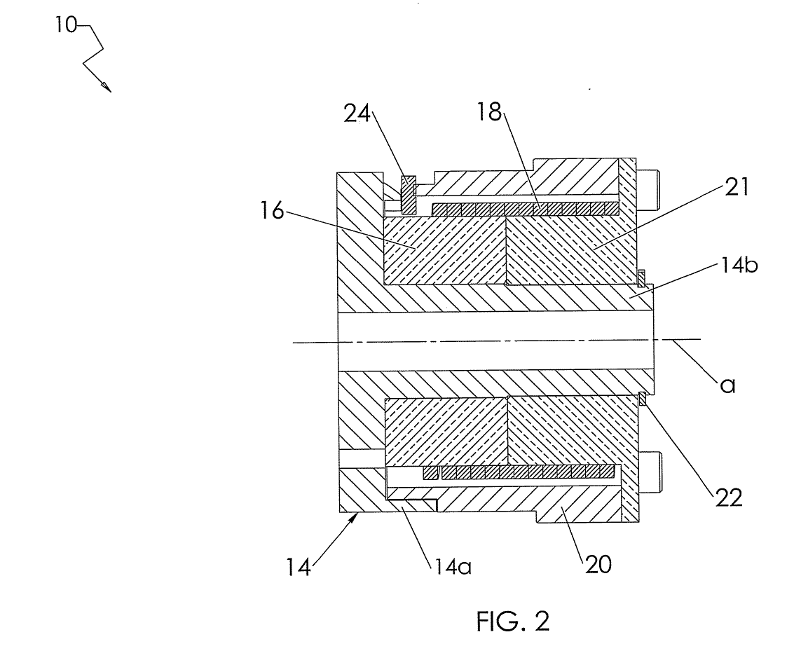

Wrap device 10 is illustrated in FIG. 1 in an exploded view, and is configured so that the various components can be assembled together. FIG. 2 illustrates a cross-sectional view of wrap device 10 when it is fully assembled in accordance with one embodiment of the present invention.

When wrap device 10 is assembled, wrap hub 16 is fixed over the shaft portion 14b of input shaft 14. For example, wrap hub 16 can be press fit onto shaft portion 14b such that the two pieces tend to rotate together about axis a. Grounding hub 21 is configured to be fixed to output hub 20 such that a portion of grounding hub 21 extends inside output hub 20. Grounding hub 21 can be fixed to output hub 20 in a variety of ways. For example, a plurality of screws or bolts (see FIG. 1) can be used to secure grounding hub 21 to output hub 20. Grounding hub 21 could also be welded or secured in other ways. Alternatively, grounding hub 21 and output hub 20 could be formed as a single unitary part.

When wrap device 10 is assembled, shaft portion 14b of input shaft 14 is inserted through grounding hub 21, which is partially contained within output hub 20. In one embodiment, a retaining ring 22 is coupled to an end of shaft portion 14b to secure the wrap device 10 together. Once assembled, the configuration of wrap hub 16, grounding hub 21, and output hub 20 create an opening in which wrap 18 is contained (See FIG. 2). Wrap 18 spans wrap hub 16 and grounding hub 21 such that a portion of wrap 18 can engage wrap hub 16 and a portion of wrap 18 can engage grounding hub 21. In one embodiment, an end of wrap 18 is fixed to grounding hub 21. Wrap 18 can be fixed to grounding hub 21 in any of a variety of ways, including pressing the wrap into a groove, having enough tightly wound wraps, using a toe-engagement feature, or other methods.

In one embodiment, wrap 18 also includes a wrap toe 24 (See FIG. 1), which is configured over wrap hub 16. Wrap device 10 is configured such that wrap toe 24 can be controllably manipulated in order to cause wrap 18 to alternatively wrap down onto and wrap open off of wrap hub 16. When wrap 18 is wrapped down onto wrap hub 16, wrap hub 16 and grounding hub 21 can be locked together. When wrap 18 is wrapped off of wrap hub 16, wrap hub 16 can rotate within wrap 18 such that wrap hub 16 and grounding hub 21 can be rotated relative to each other.

As such, in operation of one embodiment, wrap device 10 is configured such that input shaft 14 and grounded hub 20 may be rotated relative to each other in a controllable fashion. Specifically, one or the other of input shaft 14 and grounded hub 20 can be mounted to a base, while the other is mounted to a rotated member. Wrap device 10 is configured to allow positional control between the rotated member and the base by controlling wrap toe 24 and wrap 18.

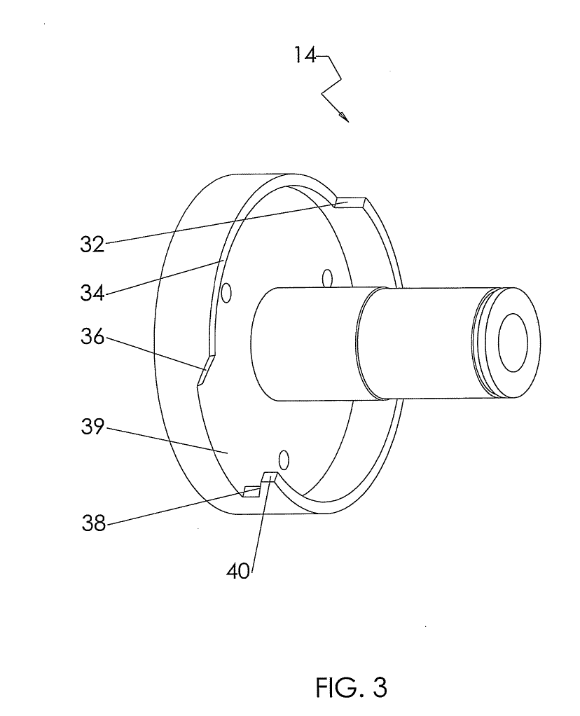

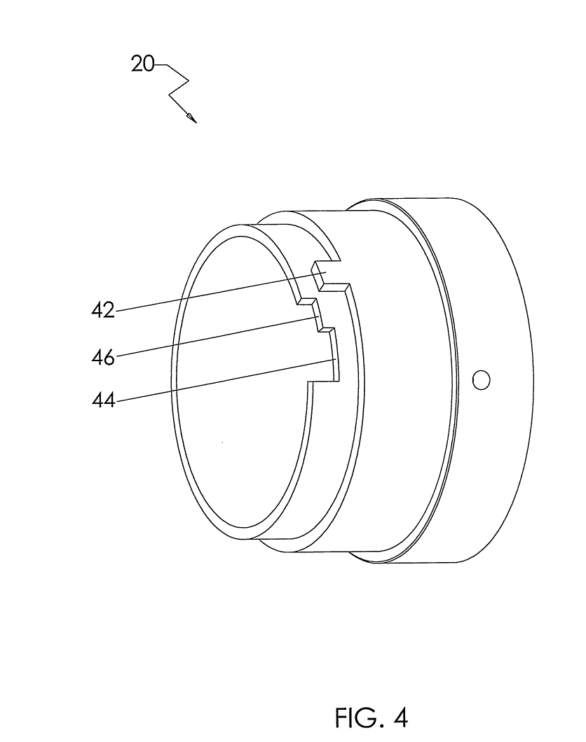

FIGS. 3 and 4 respectively illustrate input shaft 14 and grounded hub 20. In one embodiment, input shaft 14 and grounded hub 20 are configured to cooperate in controlling wrap toe 24 as input shaft 14 and grounded hub 20 are rotated relative to each other.

In one embodiment, input shaft 14 is configured with input cam features. In one example, input cam features include first travel limit 32, first input shelf 34, ramp 36, toe deflect 38, second input shelf 39 and third travel limit 40. Also in one embodiment, grounded hub 20 is configured with grounded cam features. In one example, grounded cam features include second travel limit 42, first grounded shelf 44, and second grounded shelf 46. In other embodiments, input cam features and grounded cam features include less than all these features. In other embodiments, input cam features and grounded cam features include additional features.

In one embodiment, when wrap device 10 is fully assembled, input cam features of input shaft 14 and grounded cam features of grounded hub 20 cooperate to control wrap toe 24 as input shaft 14 and grounded hub 20 are rotated relative to each other. For example, when input shaft 14 is inserted within grounded hub 20, the input cam features and the grounded cam features form a control slot into which wrap toe 24 extends. As input shaft 14 and grounded hub 20 are rotated relative to each other in the operation of wrap device 10, the control slot formed by the combination of the input cam features and the grounded cam features changes shape. This change in shape of the control slot can manipulate wrap toe 24 and thus wrap 18. Manipulation of wrap toe 24 and wrap 18 can control the operation of wrap device 10, which in one embodiment, can be used to controllably position moveable elements relative to each other.

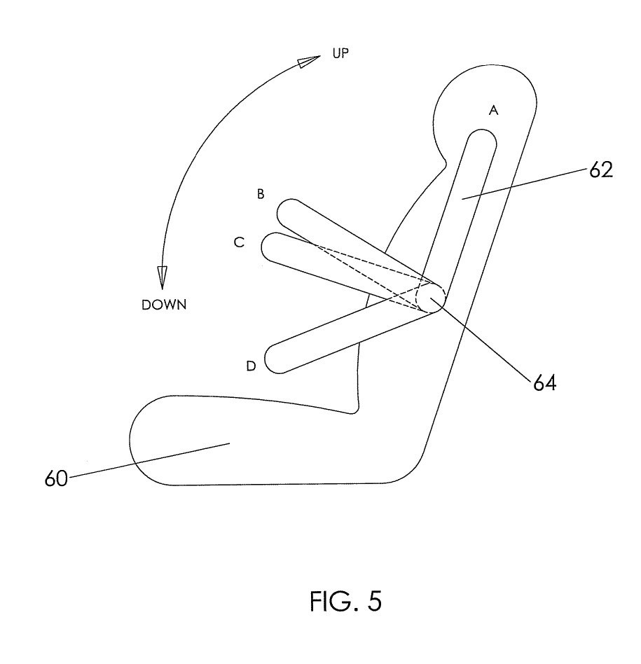

In one exemplary embodiment illustrated in FIG. 5, wrap device 10 is assembled into a chair 60 with an armrest 62. Wrap device 10 is installed at location 64 such that it facilitates the rotation of armrest 62 relative to chair 60. In one example, input shaft 14 is coupled to armrest 62, while grounded hub 20 is coupled to chair 60. In this way, wrap device 10 is configured to controllably position armrest 62 relative to chair 60.

Chair 60 and armrest 62 illustrated in FIG. 5 are just one example of wrap device 10 in operation, and various other applications for wrap device 10 are possible as well. The example of FIG. 5 is used to assist in the explanation of one application of wrap device 10, but other examples and applications are just as applicable. Furthermore, in the example, input shaft 14 is coupled to armrest 62, while grounded hub 20 is coupled to chair 60, but one skilled in the art will understand that wrap device 10 can be configured such that input shaft 14 is coupled to chair, while grounded hub 20 is coupled to armrest 62.

In operation, armrest 62 can be rotated between a “full up” position, indicated as position “A” and a “full down” position, indicated as position “D”. Various intermediate positions between these are also possible. Position “C” is indicated where armrest 62 is nearly parallel with the sitting surface of chair 60, and position “B” is indicated where armrest 62 is slightly above position C.

In operation of one embodiment of wrap device 10, wrap toe 24 and wrap 18 are controlled such that wrap device 10 is operable in a one-way mode and in a two-way mode. As used hereinafter, wrap device 10 will be referred to as “set” to the one-way mode and “reset” to the two-way mode.

When wrap device 10 is reset to the two-way mode, armrest 62 can be moved readily between positions A and B with the application of only a small force to armrest 62. When set to the one-way mode, however, armrest 62 can only be moved readily from lower positions to higher positions in the direction labeled “up” in FIG. 5 with the application of a small force to armrest 62. Application of even a significant force in the “down” direction while wrap device 10 is set in the one-way mode, will not move armrest 62 to lower positions from higher positions in the direction label down in FIG. 5. As such, once properly positioned, armrest 62 can function as a rest for a user's arm and support it in place without rotating downward.

In one embodiment, wrap device 10 can be changed from a two-way mode to a one-way mode when armrest 62 is moved all the way down to position D. In one embodiment, wrap device 10 can be changed from a one-way mode back to a two-way mode when armrest 62 is moved up to position B. This arrangement allows a user to easily store armrest 62 in position A when not in use, and also to set armrest 62 for use as a weight-bearing rest at any position between positions D and C.

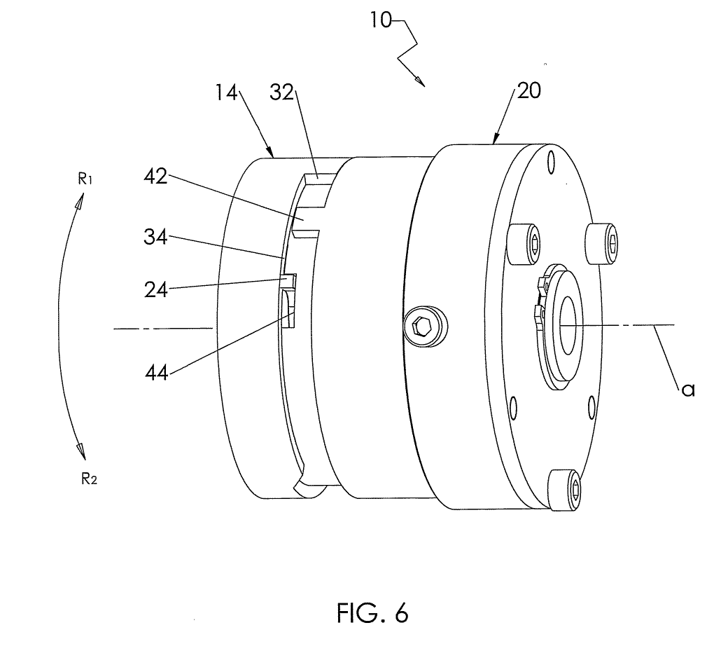

FIGS. 6-11 illustrate wrap device 10 at several varying relative positions of input shaft 14 to grounded hub 20 in accordance with one embodiment of the present invention. For ease of illustration, grounded hub 20 is considered to be mounted in a fixed angular position, while input hub 14 is rotated in first or second rotation directions R₁ and R₂ about the axis a. One skilled in the art will understand, however, that input shaft 14 can be mounted in a fixed angular position, while grounded hub 20 is rotated in first or second rotation directions R₁ and R₂ about the axis a.

FIG. 6 illustrates wrap device 10 including input shaft 14 and grounded hub 20, which are configured to be rotated relative to each other. At the stage of rotation illustrated in FIG. 6, first travel limit 32 and first input shelf 34 of input shaft 14 are visible. Also as illustrated, grounded hub 20 includes second travel limit 42 and first grounded shelf 44. Wrap toe 24 is illustrated extending out between first grounded shelf 44 and first input shelf 34. The position illustrated in FIG. 6 is comparable with armrest 62 departing position A in FIG. 5, and moving in the down direction.

In one embodiment, wrap toe 24 is configured in this position to be secured against grounded hub 20 such that wrap 18 is wrapped open off of wrap hub 16. More specifically, wrap toe 24 is secured against a step that is defined by the transition of first grounded shelf 44 to second grounded shelf 46. This step is not fully visible in FIG. 6, but is illustrated, for example, in FIG. 4. As long as wrap toe 24 is secured against the step defined by the transition between first and second grounded shelves 44 and 46, wrap 18 is prevented from wrapping down onto wrap hub 16. In this way, wrap device 10 is in the two-way mode, such that input shaft 14 can be rotated in either the first or second rotation directions R₁ and R₂ relative to grounded hub 20 about the axis a, with the application of only a small force to overcome a residual load of wrap device 10.

In one embodiment, wrap 18 is configured such that its inner diameter will engage the outer diameter of wrap hub 16 when wrap 18 is in an equilibrium state. When wrap 18 is wrapped open, however, such as when wrap toe 24 is engaged by the step defined between first and second grounded shelves 44 and 46, there is sufficient clearance for wrap hub 16 to rotate within wrap 18.

In one embodiment, first travel limit 32 on input shaft 14 and second travel limit 42 on grounded hub 20 are included so that input shaft 14 can only be rotated a limited distance in second rotation direction R₂. For example, in FIG. 6, it can be seen that as input shaft 14 is rotated in second rotation direction R₂ first travel limit 32 and second travel limit 42 will interfere thereby preventing any further rotation in that direction. Such a feature may be useful, for example, when wrap device 10 is used in an application such as that illustrated in FIG. 5. In such an application, when armrest 62 reached position A, for example, the engagement first travel limit 32 and second travel limit 42 can be utilized to prevent armrest 62 from continued rotation beyond the back of seat 60.

Again, as long as wrap toe 24 is secured against the step defined by the transition between first and second grounded shelves 44 and 46, wrap 18 is prevented from wrapping down onto wrap hub 16 and input shaft 14 can be rotated in first rotation direction R₁ relative to grounded hub 20. As input shaft 14 is rotated in first rotation direction R₁, wrap toe 24 moves adjacent first input shelf 34 without interfering with it.

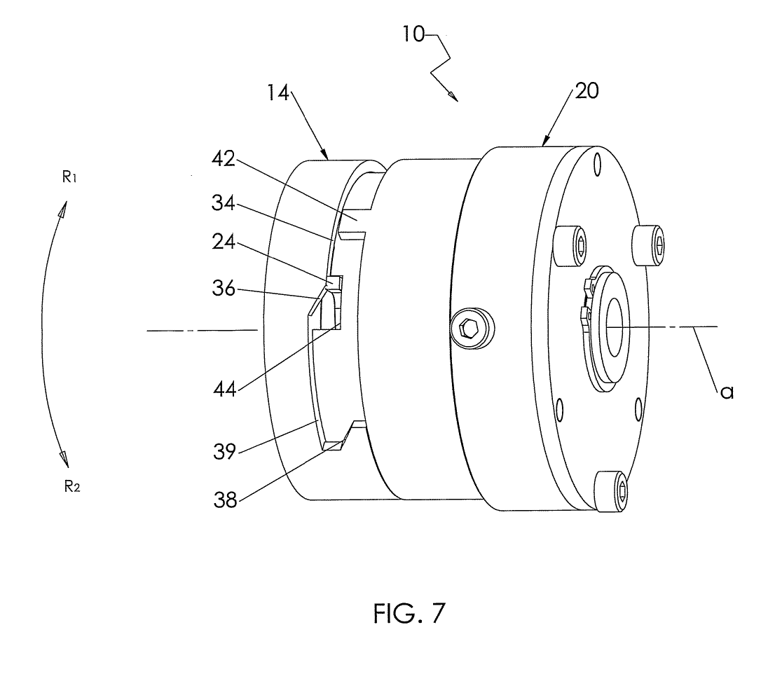

FIG. 7 illustrates wrap device 10 after input shaft 14 has been further rotated in the first rotation direction R₁ relative to grounded hub 20 compared to the positions illustrated in FIG. 6. In FIG. 7, input shaft 14 has been rotated in the first rotation direction R₁ such that wrap toe 24 has traveled along first input shelf 34 and is just adjacent ramp 36. Because wrap toe 24 is still secured against the step defined by the transition between first and second grounded shelves 44 and 46, wrap 18 is still prevented from wrapping down onto wrap hub 16 such that wrap device 10 is in a two-way mode. In the two-way mode, input shaft 14 can be rotated in both first and second rotation directions R₁ and R₂ relative to grounded hub 20.

In one embodiment where wrap device 10 is installed in an application such as that illustrated in FIG. 5 at location 64, the relative positions of input shaft 14 and grounded hub 20 illustrated in FIG. 7 may be approximately representative of when armrest 62 is in position B in FIG. 5. For example, as armrest 62 is rotated in the down direction indicated in the figure from position A down to position B, the relative positions of input shaft 14 and grounded hub 20 in wrap device 10 is approximately illustrated in FIG. 7.

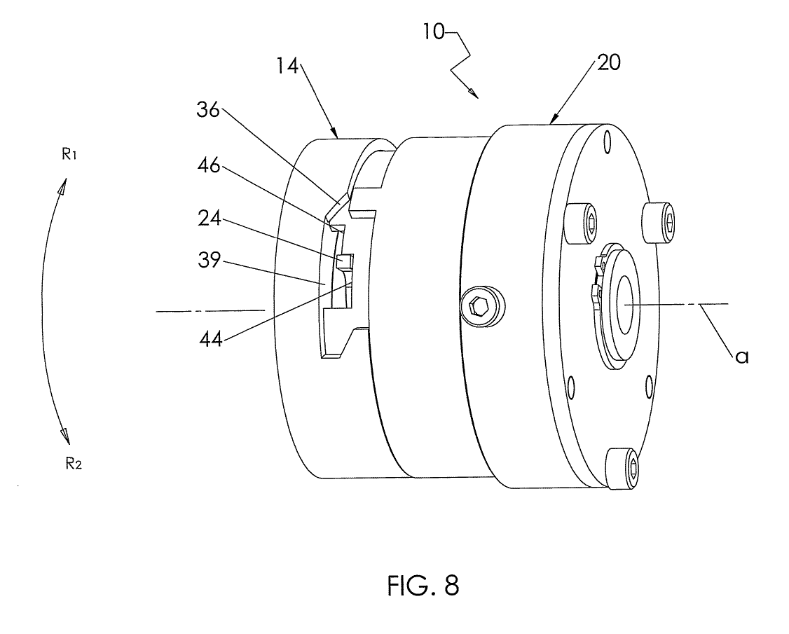

FIG. 8 illustrates wrap device 10 after input shaft 14 has been further rotated in the first rotation direction R₁ relative to grounded hub 20 compared to the positions illustrated in FIG. 7. In FIG. 8, input shaft 14 has been rotated in the first rotation direction R₁ such that wrap toe 24 has traveled past ramp 36 and is out over second input shelf 39. Because wrap toe 24 is still secured against the step defined by the transition between first and second grounded shelves 44 and 46, however, wrap 18 is still prevented from wrapping down onto wrap hub 16 such that wrap device 10 is still in a two-way mode. In the two-way mode input shaft 14 can be rotated in both first and second rotation directions R₁ and R₂ relative to grounded hub 20. Second grounded shelf 46 is visible in FIG. 8, because in the illustrated position, second grounded shelf 46 of grounded hub 20 has rotated to be adjacent to second input shelf 39.

In one embodiment where wrap device 10 is installed in an application such as that illustrated in FIG. 5 at location 64, the relative positions of input shaft 14 and grounded hub 20 illustrated in FIG. 8 may be approximately representative of when armrest 62 is between position C and D in FIG. 5.

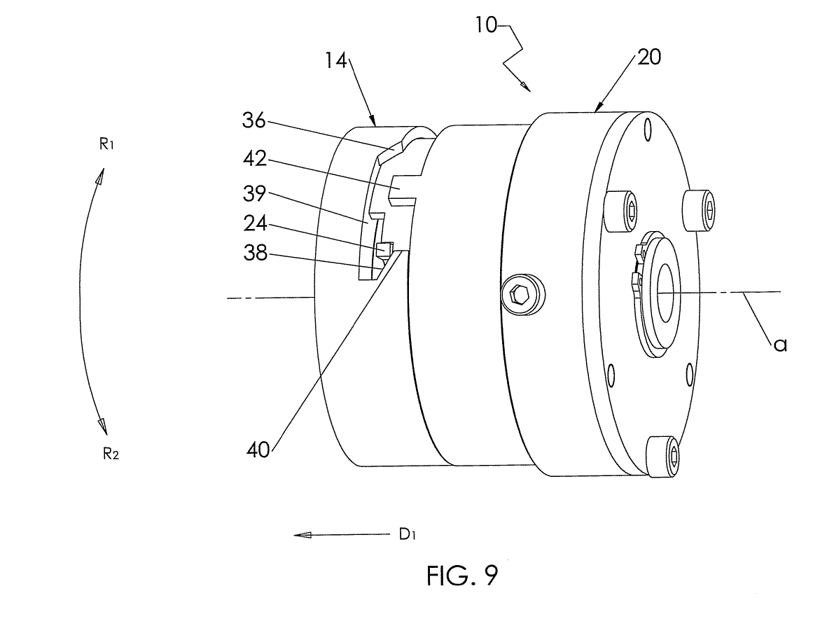

FIG. 9 illustrates wrap device 10 after input shaft 14 has been further rotated in the first rotation direction R₁ relative to grounded hub 20 compared to the positions illustrated in FIG. 8. In FIG. 9, input shaft 14 has been rotated in the first rotation direction R₁ such that wrap toe 24 has traveled up against toe deflect 38. Any further rotation of input shaft 14 in the first rotation direction R₁ causes wrap toe 24 to deflect against toe deflect 38 in a first deflection direction D₁, which in one example is generally perpendicular to first and second rotation directions R₁ and R₂ and generally parallel to axis a. As such, this deflection causes wrap toe 24 to move off of the step defined by the transition between first and second grounded shelves 44 and 46.

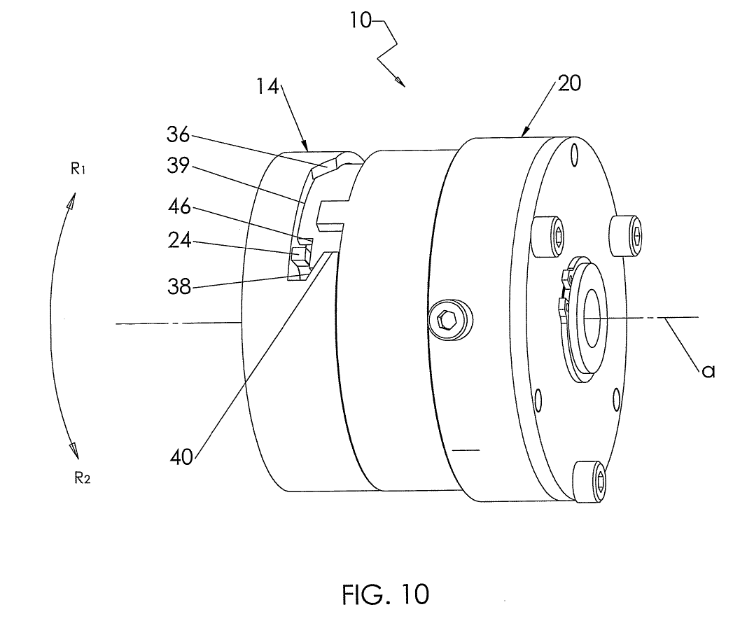

FIG. 10 illustrates wrap device 10 after input shaft 14 has been further rotated in the first rotation direction R₁ relative to grounded hub 20 such that wrap toe 24 has deflected against toe deflect 38 in the first deflection direction D₁ and moved off the step defined by the transition between first and second grounded shelves 44 and 46. As such, wrap toe 24 has wrapped back in the first rotation direction R₁ below the second grounded shelf 46 and wrap 18 has wrapped down onto wrap hub 16.

In one embodiment, this release of wrap toe 24 off of the step defined between first and second grounded shelves 44 and 46 allows wrap 18 to wrap down onto wrap hub 16. When wrap 18 wraps down onto wrap hub 16, wrap device 10 transitions from the two-way mode and is set in the one-way mode. In this one-way mode, when input shaft 14 is rotated in the first rotation direction R₁ relative to grounded hub 20, wrap 18 wraps down on wrap hub 16 preventing further rotation in that direction. In one example, the release of wrap toe 24 off of the step defined between first and second grounded shelves 44 and 46 allows wrap 18 to return to its equilibrium state, in which its inner diameter engages wrap hub 16.

In one embodiment, wrap device 10 is configured such that it would take substantial force to overcome the friction between wrap 18 and wrap hub 16 to rotate in the first rotation direction R₁ in the one-way mode, thereby effectively preventing rotation in the first rotation direction R₁. In this one-way mode, input shaft 14 can still be rotated in the second rotation direction R₂ relative to grounded hub 20.

In one exemplary application such as the illustrated in FIG. 5, wrap device 10 can be configured in a one-way mode to support significant downward force from a user's arm without allowing movement in the down direction. In one embodiment where wrap device 10 is installed in an application such as that illustrated in FIG. 5 at location 64, the relative positions of input shaft 14 and grounded hub 20 illustrated in FIG. 10 are approximately representative of when armrest 62 is in position D in FIG. 5. For example, as armrest 62 is rotated in the down direction indicated in the figure from position C down to position D, the relative positions of input shaft 14 and grounded hub 20 in wrap device 10 is approximately illustrated in FIG. 10.

Moving armrest 62 to position D can thus set wrap device 10 into the one-way mode from the two-way mode such that the user can still rotate armrest 62 up into a desired position, and then once positioned there, even significant force applied to armrest 62 in the down direction will be supported such that armrest 62 will not rotate down. As such, once positioned in the desired position, armrest 62 functions as a rest and will not rotate even when subjected to significant force of a resting arm of a user.

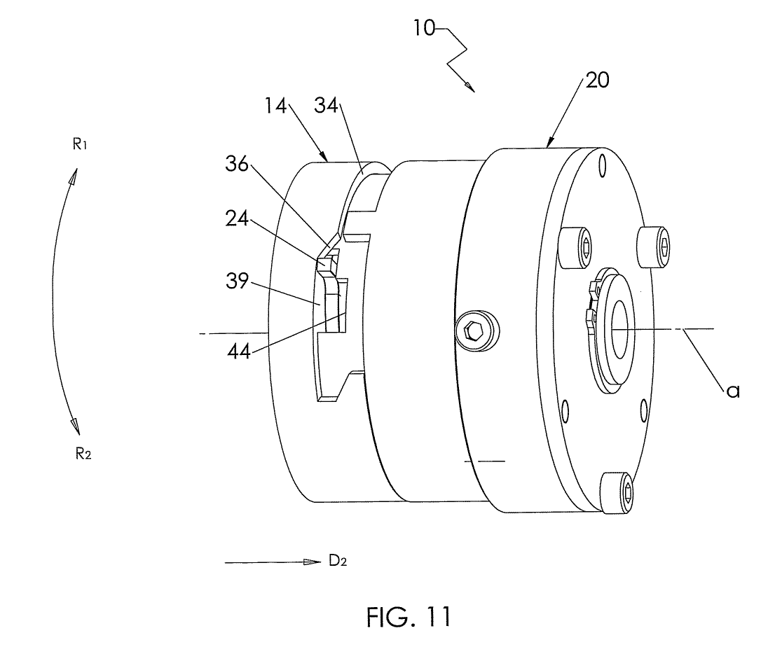

Wrap device 10 can also be reset back to the two-way mode from the one-way mode, by rotating input shaft 14 in the second rotation direction R₂ relative to grounded hub 20. FIG. 11 illustrates how wrap device 10 can be reset to the two-way mode. As input shaft 14 rotates in the second rotation direction R₂ relative to grounded hub 20, wrap toe 24 will engage ramp 36 such that it will be deflected in a second deflection direction D₂. As wrap toe 24 moves up ramp 36 onto first input shelf 34, it will reengage with the step defined between first and second grounded shelves 44 and 46. As such, once wrap toe 24 is secured against the step between first and second grounded shelves 44 and 46, wrap 18 is prevented from wrapping down onto wrap hub 16. Reset back in the two-way mode, input shaft 14 can be rotated in either the first or second rotation directions R₁ and R₂ relative to grounded hub 20 about the axis a.

In one exemplary application such as the illustrated in FIG. 5, wrap device 10 can be configured to be reset back into the two-way mode so that armrest 62 can be rotated both up and down. In one embodiment where wrap device 10 is installed in an application such as that illustrated in FIG. 5 at location 64, the relative positions of input shaft 14 and grounded hub 20 illustrated in FIG. 11 are approximately representative of when armrest 62 is in position C in FIG. 5. For example, as armrest 62 is rotated in the up direction indicated in the figure from position D up to position C, the relative positions of input shaft 14 and grounded hub 20 in wrap device 10 is approximately illustrated in FIG. 11.

In one embodiment where wrap device 10 is configured in an application such as that illustrated in FIG. 5, first travel limit 32, second travel limit 42 and third travel limit 40 are configured to only allow a certain range of relative rotation. For example, in one embodiment, armrest 62 can only be rotated up to position A, and then first travel limit 32 and second travel limit 42 will contact such that further rotation of armrest 62 is prevented. Similarly, armrest 62 can only be rotated down to position D, and then second travel limit 42 and third travel limit 40 will contact such that further rotation of armrest 62 is prevented. One skilled in the art will understand that first through third travel limits 32, 42 and 40 can be configured to allow a larger range of rotation, or even be configured to avoid engagement between them at all so that there is no restriction on rotation, and input shaft 14 and grounded hub 20 can be rotated 360 degrees.

In one embodiment, the release of wrap toe 24 off the step between first and second grounded shelves 44 and 46 to set wrap device into the one-way mode can be accomplished without toe deflect 38. In one example, wrap 18 and wrap toe 24 are configured such that wrap toe 24 can be moved in the first deflection direction D₁ as soon as wrap toe 24 clears first input shelf 34.

For example, viewing FIGS. 7 and 8, as input shaft 14 is rotated in the first rotation direction R₁, wrap toe 24 travels off first input shelf 34 over ramp 36, and once past ramp 36, over second input shelf 39. In one embodiment of wrap device 10, a slight reverse rotation, that is, a rotation of input shaft 14 in the second rotation direction R₂, will release wrap toe 24 from the step between first and second grounded shelves 44 and 46. As such, when wrap toe 24 has moved off first input shelf 34 and is over second input shelf 39, this slight reverse rotation in the second rotation direction R₂, or “reverse set” feature, will change wrap device 10 from the two-way mode to the one-way mode.

In one embodiment where wrap device 10 is configured in an application such as that illustrated in FIG. 5, such a reverse set feature can be useful. For example, with such a configuration, armrest 62 would not need to be rotated down to position D to in order to set wrap device 10 into the one-way mode from the two-way mode. Instead, a user could simply rotate armrest down to a desired position while in the two-way mode, and then reverse set by reversing armrest 62 to rotate slightly up such that wrap device will set to the one-way mode. Once there, even significant force applied to armrest 62 in the down direction will be supported such that armrest 62 will not rotate down.

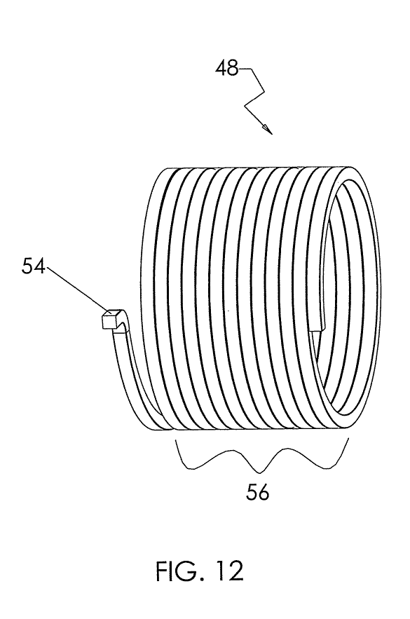

In one embodiment, the reverse set configuration can be accomplished with a wrap 48 illustrated in FIG. 12. Wrap 48 is configured that wrap toe 54 extends axially out from main portion 56 of wrap 48 when wrap 48 is in an equilibrium state. When such a wrap 48 is configured in wrap device 10, ramp 36 will force wrap toe 54 adjacent main portion 56 of wrap 48 such that wrap toe 54 engages the step defined between first and second grounded shelves 44 and 46. When wrap toe 48 travels off first input shelf 34 and over second input shelf 39, however, even a slight reverse rotation will cause wrap 48 to return to its equilibrium state. In other words, under reverse rotation wrap toe 54 will move away from main portion 56 of wrap 48 in the first deflection direction D₁. This reverse set will change wrap device 10 from the two-way mode to the one-way mode.

Various other configurations of wraps 18 and 48 can also be implemented to achieve the reverse set configuration for wrap device 10. For example, wrap 18 can be wound such that it is tapered gradually toward the end with wrap toe 24. Also, the diameter of wrap 18 can be slightly tapered so that there is more interference between wrap 18 and wrap hub 16 away from wrap toe 24 and less interference between wrap 18 and wrap hub 16 closer to wrap toe 24. These and various other techniques can allow achievement of the reverse set configuration for wrap device 10.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, although wrap 18 is illustrated in the figures as alternatively wrapping down onto and wrapping open off of wrap hub 16 as wrap toe is controlled by cam features, a wrap hub could also be configured as a hollowed cylinder, such that a wrap could be configured inside the wrap hub. As such, the wrap could alternatively wrap out against the interior of the wrap hub to engage it in a one-way mode, and then wrap in away from the wrap hub changing to a two-way mode. The changing between the modes could still be accomplished by controlling wrap toe with cam features.

This application is intended to cover any adaptations or variations of the specific embodiments discussed herein. Therefore, it is intended that this invention be limited only by the claims and the equivalents thereof.

What is claimed is:

1. A wrap device comprising:
a first hub configured with first cam features;
a second hub configured with second cam features, the first and second hubs configured so that one is rotatable relative to the other about an axis in first and second circumferential directions with respect to the hubs; and
a wrap configured with a wrap toe and configured to span the first and second hubs;
wherein the first and second cam features of the first and second hub control the wrap toe upon relative rotation of first and second hubs such that the wrap toe is deflected in at least one of the first and second circumferential directions, and such that the wrap toe is deflected in at least one of a first and a second deflection directions, which are each different than the first and second circumferential directions.

2. The wrap device of claim 1, wherein the second deflection direction is generally perpendicular to the first and second circumferential directions.

3. The wrap device of claim 2, wherein the first cam features comprise a ramp configured to deflect the wrap toe in the second deflection direction upon relative rotation of first and second hubs, the second deflection direction being generally parallel to the axis.

4. The wrap device of claim 3, wherein the second cam features comprise a step configured such that when the wrap toe deflects in the second deflection direction it engages the step.

5. The wrap device of claim 4 configured such that when the wrap toe engages the step the wrap is prevented from wrapping onto the first hub such that first and second hubs can be rotated relative to each other in either the first and second circumferential directions.

6. The wrap device of claim 1, wherein the second cam features comprise a toe deflect configured to deflect the wrap toe in a first deflection direction, which is opposite the second deflection direction, upon relative rotation of first and second hubs.

7. The wrap device of claim 6, wherein the second cam features comprise a step configured such that when the wrap toe deflects in the first deflection direction, the wrap toe disengages the step allowing the wrap to wrap onto the first hub such that first and second hubs can be rotated relative to each other in only one of the first and second circumferential directions.

8. The wrap device of claim 1, wherein the first and second cam features comprise travel limits configured to engage each other such that a limited range of relative rotation is defined between the first and second hubs.

9. The wrap device of claim 1, wherein the first and second cam features and the wrap are configured such that when relative circumferential directions of rotation between the first and second hubs are reversed, the wrap toe moves in a direction parallel to an axis about which the first and second hubs rotate.

10. The wrap device of claim 1, wherein the first hub comprises an input cam portion having the cam features, an input shaft portion, and a wrap hub portion secured over the input shaft portion, the wrap configured to alternatively wrap down onto and wrap open off of the wrap hub portion.

11. The wrap device of claim 10, wherein second hub comprises an output hub and a grounding hub each configured to be secured over the input shaft portion, the wrap secured to the grounding hub.

12. The wrap device of claim 1, wherein the first hub is coupled to a seat and the second hub is coupled to an armrest such that the wrap device controls relative rotation of the armrest to the seat.

13. A wrap device comprising:
an input having input cam features;
an output having output cam features, the input and output configured for relative rotation; and
a wrap engaging the input and output and having a wrap toe;
wherein the input and output cam features are configured to engage the wrap toe such that the wrap device changes from a one-way mode to a two-way mode by certain relative positions between the input and output; and
wherein the input and output cam features are configured to engage the wrap toe such that the wrap device changes from the two-way mode to the one-way mode by certain relative rotation of the input and output.

14. The wrap device of claim 13, wherein the input and output cam features are configured to engage the wrap toe such that the wrap device changes from the two-way mode to the one-way mode upon by the relative positions of the input and output.

15. The wrap device of claim 14, wherein the output cam features comprise a toe deflect configured to deflect the wrap toe a direction parallel to an axis about which the input and output rotate as the input and output are rotated relative to each other.

16. The wrap device of claim 13, wherein the input and output cam features are configured to engage the wrap toe such that the wrap device changes from the two-way mode to the one-way mode upon by the relative motions of the input and output.

17. The wrap device of claim 16, wherein the input and output cam features and the wrap are configured such that when the relative direction of rotation between the input and output are reversed, the wrap toe moves in a direction parallel to an axis about which the input and output rotate.

18. The wrap device of claim 13, wherein the input comprises an input cam portion having the cam features and a shaft portion over which the output is configured, the input being an integral single piece.

19. The wrap device of claim 13, wherein the input is coupled to an armrest and the output is coupled to a seat such that the wrap device controls relative rotation of the armrest to the seat.

20. A wrap device comprising:
an input having input cam features;
an output having output cam features, the input and output configured for relative rotation; and
a wrap engaging the input and output and having a wrap toe;
wherein certain relative rotation of the input and output causes the input and output cam features to engage the wrap toe such that the wrap device changes from a one-way mode to a two-way mode; and
wherein certain relative rotation of the input and output causes the wrap device to change from the two-way mode to the one-way mode.

21. A wrap device comprising:
a first hub configured with first cam features;
a second hub configured with second cam features, the first and second hubs configured so that one is rotatable relative to the other about an axis;
a control slot defined by the first and second cam features; and
a wrap configured with a wrap toe, the wrap configured to be fixed to the second hub and configured to be alternatively engaged and disengaged with the first hub;
wherein the control slot controls the wrap toe upon relative rotation of first and second hubs thereby causing the wrap toe to alternatively wrap down on the first hub and wrap off of the first hub.
